(19) United States
(12) Patent Application Publication
(10) Pub. No.: US 2017/0131785 A1
(43) Pub. Date: May 11, 2017

(54) METHOD AND APPARATUS FOR PROVIDING INTERFACE INTERACTING WITH USER BY MEANS OF NUI DEVICE

(71) Applicant: STARSHIP VENDING-MACHINE CORP., Seoul (KR)

(72) Inventors: Su-young JEON, Seoul (KR); Ji-yong KWON, Seoul (KR)

(21) Appl. No.: 15/414,609

(22) Filed: Jan. 24, 2017

Related U.S. Application Data
(63) Continuation of application No. PCT/KR2015/006431, filed on Jun. 24, 2015.

(30) Foreign Application Priority Data
Jul. 31, 2014 (KR) 10-2014-0098129

(51) Int. Cl. G06F 3/01; G06F 3/0482; G06F 3/0481

(52) U.S. Cl. CPC G06F 3/017; G06F 3/04817; G06F 3/0482; G06F 3/04815

(57) ABSTRACT

An apparatus for providing an interface interacting with a user via an NUI device, according to an embodiment of the present invention, provides an interface that enables the intuitive use of an application while minimizing the relationships between locations of a hand of a user and locations of a cursor on the screen of an image display device. Accordingly, a user can select an icon via only a simple input, such as an input adapted to rotate a hand action or an input adapted to move a hand action in one direction, thereby providing a convenient and optimized interface environment for the user.

### TECHNICAL FIELD

The present invention relates to a method and apparatus for providing an interface interacting with a user via an NUI device, and more particularly to a method and apparatus for providing an interface interacting with a user via an NUI device, which receives an action of a user via an NUI device and incorporates the action of the user into the operation of an interface.

### BACKGROUND ART

A Natural User Interface Device (hereinafter referred to as the “NUI device”) refers to any type of device that recognizes an action or pose of a user by using a mounted image sensor and a mounted depth sensor or a voice of a user via a mounted microphone and then uses the recognized information for an interactive command for a specific device or specific software.

As a conventional technology using an NUI device, Korean Patent Application Publication No. 10-2014-0028064 (published on Mar. 7, 2014) discloses a concept of recognizing an open hand or a closed hand and running software in accordance with the recognized information. This method may be viewed as an extension of an interaction method using a mouse/a track pad/a track ball that is widely used in modern computers, etc.

To facilitate the above interaction method, provided is an interface in which commands executable within an application are represented by using buttons arranged in a grid pattern and the application is executable by moving a cursor through actions of a user. However, this method cannot be viewed as an interface optimized for a user in that a user should constantly learn the relationships between locations of his or her hand and locations of a cursor on a screen and in that there occurs inconvenience in which, when information about a button displayed on an edge of the screen is desired to be input, the information about the button can be input only when the user greatly moves his or her arm.

Meanwhile, the above-described background technology corresponds to technical information that has been possessed by the present inventor in order to contrive the present invention or that has been acquired in the process of contriving the present invention, and cannot be necessarily viewed as a well-known technology that had been known to the public before the filing of the present invention.

### DISCLOSURE

### Technical Problem

An object of an embodiment of the present invention is to provide an interface that enables the intuitive use of an application while minimizing the relationships between locations of a hand of a user and locations of a cursor on the screen of an image display device.

### Technical Solution

As a technical solution for accomplishing the above object, according to a first aspect of the present invention, there is provided a method for providing an interface interacting with a user via an NUI device, which is performed by an apparatus for providing an interface, the method including: (a) providing an interactive interface, in which a plurality of icons are circularly arranged, to an image display device; (b) recognizing, by a Natural User Interface (NUI) device, an action of a user, and receiving recognition information regarding the action of the user from the NUI device; (c) analyzing the recognition information, and generating action information regarding any one of a user action of rotating the plurality of icons circularly arranged and a user action of selecting any one of the plurality of icons; and (d) providing an interactive interface, in which a command has been executed in accordance with the action information, to the image display device.

Meanwhile, according to a second aspect of the present invention, there is provided an apparatus for providing an interface interacting with a user via an NUI device, the apparatus including: an interface provision unit configured to provide an interactive interface, in which a plurality of icons are circularly arranged, to an image display device; a recognition information reception unit configured to receive recognition information regarding an action of a user, recognized by a Natural User Interface (NUI) device, from the NUI device; an action information generation unit configured to analyze the recognition information and generate action information regarding any one of a user action of rotating the plurality of icons circularly arranged and a user action of selecting any one of the plurality of icons; and an execution information provision unit configured to provide execution information adapted to execute an interactive interface in accordance with the action information to the image display device.

Meanwhile, according to a third aspect, there is provided a computer program stored in a computer-readable storage medium to perform the method for providing an interface interacting with a user via an NUI device according to the first aspect.

Meanwhile, according to a fourth aspect, there is provided a computer-readable storage medium having stored thereon a computer program code for performing the method for providing an interface interacting with a user via an NUI device according to the first aspect.

### Advantageous Effects

An embodiment of the present invention provides the interactive interface adapted to enable an icon to be selected via only a simple input, such as an input adapted to rotate a hand action or an input adapted to move a hand action in one direction, thereby providing a convenient and optimized interface environment for the user. Furthermore, the interactive interface is configured in a 3D spiral form, and thus a large number of icons can be included and an intuitive interface environment can be provided for a user.

### DESCRIPTION OF DRAWINGS

FIG. 1 is a diagram showing the configuration of a system for providing an interface interacting with a user via an NUI device according to an embodiment of the present invention;

FIG. 2 is a diagram showing the configuration of an apparatus for providing an interface interacting with a user via an NUI device according to an embodiment of the present invention;

FIG. 3 is a block diagram showing the configuration of an action information generation unit according to an embodiment of the present invention;

FIGS. 4 to 8 are diagrams illustrating an example of the operation of a circular interactive interface according to an embodiment of the present invention;

FIGS. 9 to 13 are diagrams illustrating an example of the operation of a spiral interactive interface according to an embodiment of the present invention;

FIG. 14 is a diagram illustrating an example of the operation of a spiral interactive interface according to another embodiment of the present invention; and

FIG. 15 is a flowchart illustrating a method for providing an interface interacting with a user via an NUI device according to an embodiment of the present invention.

### MODE FOR INVENTION

Embodiments of the present invention will be described in detail below with reference to the accompanying drawings so that those having ordinary knowledge in the art to which the present invention pertains can easily practice the present invention. However, the present invention may be implemented in various different forms, and are not limited to the embodiments described herein. Furthermore, in the drawings, parts unrelated to descriptions are omitted in order to clearly describe the present invention, and similar reference symbols are assigned to similar components throughout the specification.

Throughout the specification, when a part is described as being connected to another part, this includes not only a case where they are directly connected to each other but also a case where they are electrically connected to each other with another element interposed therebetween. Furthermore, when a part is described as including a component, this means that another component is not be excluded from the part but may be included in the part, unless particularly described to the contrary.

The present invention will be described in detail below with reference to the accompanying diagrams.

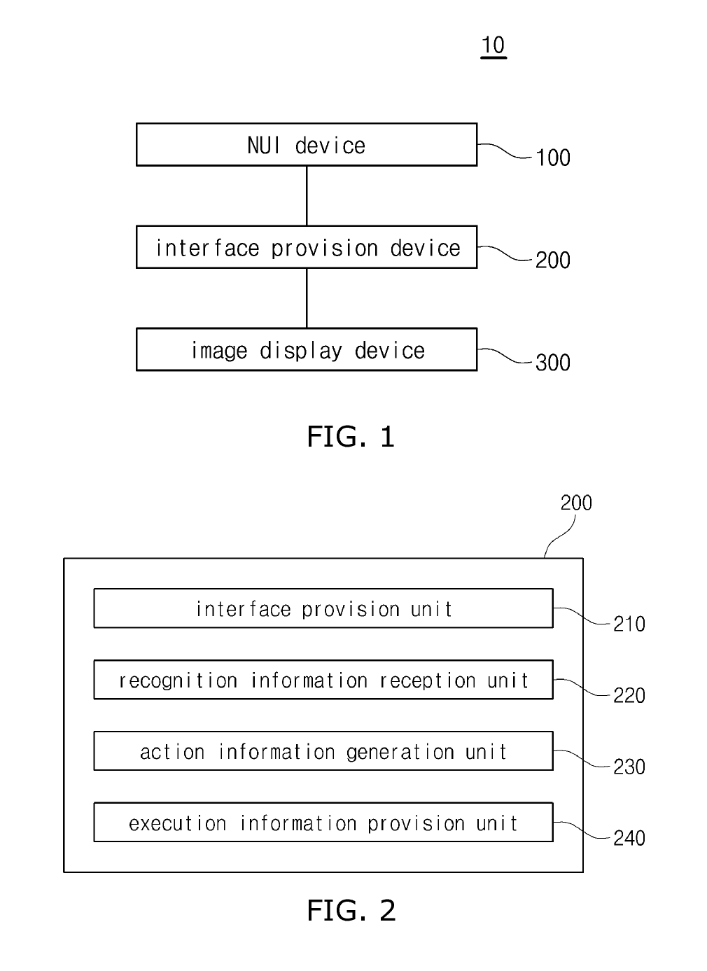

Referring to FIG. 1, a system 10 according to an embodiment of the present invention includes an NUI device 100, an interface provision device 200, and an image display device 300.

The NUI device 100 refers to any device that can recognize an action, pose or voice of a user by means of at least one of an image sensor, a depth sensor, and a voice recognition sensor and that can use the recognized action, pose or voice as a command for a software program or an application. Representatives of the NUI device 100 may include a tablet PC on which a touch screen is mounted, a smartphone, a depth camera, etc. The NUI device 100 according to an embodiment of the present invention is preferably a device that is capable of photographing an action of a user and extracting action recognition information, like a depth camera.

The NUI device 100 generates recognition information, including at least one of information about the location of a hand, finger or joint of a user, information about the rotation of the hand, finger or joint of the user, and information about the opening or clenching of a hand of the user, by photographing all or part of the body of the user, and transmits the recognition information to the interface provision device 200 via a wired/wireless communication means.

The interface provision device 200 provides an interactive interface via the image display device 300. Furthermore, the interface provision device 200 generates action information by analyzing the action of the user via the recognition information received from the NUI device 100, and transfers execution information, adapted to execute the interactive interface in accordance with a command included in the generated action information, to the image display device 300. That is, the interface provision device 200 analyzes the action of the user, and transmits the results of the operation of the interactive interface corresponding to the action of the user to the image display device 300 via the wired/wireless communication means.

The interface provision device 200 may be implemented as a computer, a portable terminal, a television, a wearable device or the like that is connectable to another terminal and a server. In this case, the computer includes, for example, a notebook, a desktop, a laptop, etc. on which a web browser has been installed. The portable terminal is, for example, a wireless communication device ensuring portability and mobility, and may include all types of handheld-based wireless communication devices, such as a smartphone. Furthermore, the wearable device is, for example, an information processing device of a type that can be directly worn on a human body, such as a watch, glasses, an accessory, a dress, shoes, or the like, and may be connected to a remote server or another terminal over a network directly or by way of another information processing device.

The image display device 300 is a device for displaying the interactive interface in accordance with the execution information received from the interface provision device 200, and may be any type of device capable of displaying an image, such as a computer monitor, a TV, a projector, Google Glasses, or the like.

Meanwhile, the interface provision device 200 may be configured to include the image display device 300. For example, there is a case where the interface provision device 200 is mounted with a display module, as in a notebook, a smartphone, a tablet PC, or the like.

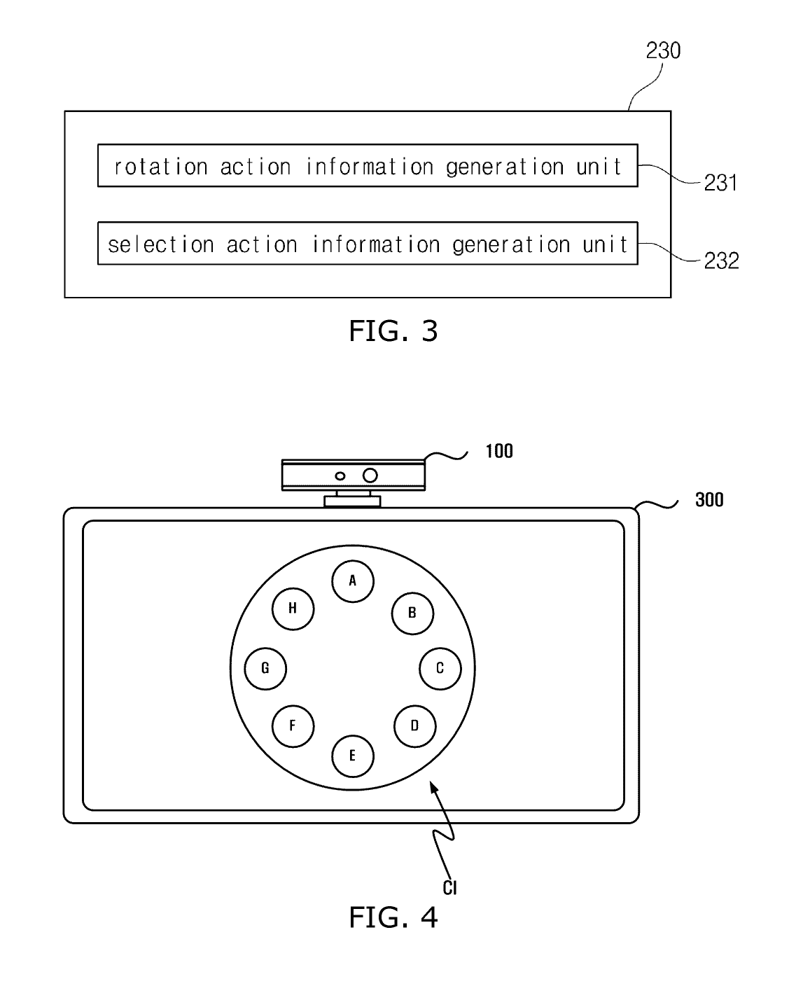

The configuration of the interface provision device 200 according to an embodiment of the present invention will be described in greater detail with reference to FIGS. 2 and 3.

An interface provision unit 210 provides the interactive interface for the user by transmitting interactive interface information to the image display device 300. Referring to FIG. 4, a circular interactive interface CI according to an embodiment of the present invention is shown on the screen of the image display device 300. The circular interactive interface CI includes a plurality of icons arranged in a circular form within a circular boundary. Each of the icons is a command button including an executable command for a specific application. For example, each of the icons may include an executable command included in an exe file, or may be a button linked to an exe file. Furthermore, the icons all include respective executable commands for different applications. In this case, the application includes a software program, a program adapted to execute an internal function of a software program, or a program adapted to execute another function related to hardware. Furthermore, each of the icons may be a high-level icon for the icons of a specific low-level group. In this case, when the high-level icon is clicked, the icons of the low-level group appear.

A recognition information reception unit 220 receives the recognition information based on the recognition of the action of a user from the NUI device 100. When the user performs an action of seeming to rotate a dial with his or her index finger, the NUI device 100 generates recognition information related to the action, and transmits the generated recognition information to the recognition information reception unit 220. The recognition information is information including information about the location of a hand, a finger or a joint of the user, information about the rotation thereof, and/or the like, as described above. For example, the recognition information includes information about a change in the location of an index finger, information about clenching of fingers exclusive of the index finger, etc. Furthermore, the recognition information reception unit 220 receives and stores a number of pieces of recognition information smaller than a specific number (that is, an amount of data smaller than a specific amount) in a specific period of time (for example, 0.5 or more minutes).

An action information generation unit 230 determines, based on the received recognition information, which of \textcircled{1} a user action of rotating a plurality of icons and \textcircled{2} a user action of selecting any one of the plurality of icons corresponds to the action of the user, or \textcircled{3} whether an action that can be recognized by the interactive interface has been input, and generates corresponding action information.

More specifically, referring to FIG. 3, the action information generation unit 230 includes a rotation action information generation unit 231, and a selection action information generation unit 232.

When preset rotation action recognition information and corresponding recognition information are included in the received recognition information, the action information generation unit 230 determines that the action of the user is the action \textcircled{1} (i.e., a user action of rotating a plurality of icons), and transfers the recognition information to the rotation action information generation unit 231. In contrast, when preset rotation action recognition information and corresponding recognition information are not included in the received recognition information, the action information generation unit 230 determines that the action of the user is state \textcircled{2} or \textcircled{3}, and transfers the recognition information to the selection action information generation unit 232. In this case, the preset rotation action recognition information may be recognition information the shape of which can be maintained regardless of the location of the joint of the user for a predetermined period of time or longer, such as an action of clenching a hand, an action of bringing a thumb and an index finger into contact with each other, or the like.

The rotation action information generation unit 231 calculates values regarding the direction and extent of the rotation of the plurality of icons intended by the user, and generates rotation action information including the direction and extent of the rotation.

More specifically, the rotation action information generation unit 231 represents information about successive locations of the hand, finger or joint of the user, included in the recognition information, with location sequence information, as expressed by Equation 1 below:

H={p₀·p₁·p₂. . . pₙ₋₁}·pᵢ=[xᵢ·yᵢ]^{T} <Equation 1>

H is the coordinate information of the location sequence information, and pᵢ is a column vector respective of coordinates.

Thereafter, the rotation action information generation unit 231 calculates the location of the center of a circle and the radius of the circle approximated via the location sequence information H by substituting the location sequence information H into circular approximation via a least-square method in order to calculate the direction and extent of the rotation. The location of the center and radius of the circle approximated via the location sequence information H refers to the location of the center and radius of a circle or an arc drawn by the action of a hand, finger or joint of the user.

More specifically, first, it is assumed that the equation of the circle is expressed by Equation 2 below:

ax²+ay²+bx+cy+1=0 <Equation 2>

In this case, a≠0. Thereafter, coefficients a, b and c of the circle that maximally approximate the location sequence information H can be obtained by obtaining the values of a, b, and c that enable the energy function of Equation 3 to have the minimum value.

$$e ( a , b , c ) = \frac{1}{2} {\sum }_{i = 0}^{n - 1} {‖ a ( {x}_{i}^{2} + {y}_{i}^{2} ) + {bx}_{i} + {cy}_{i} + 1 ‖}^{2} \qquad 〈 Equation 3 〉$$

More specifically, the coefficients a, b, and c of the circle that minimize the energy function of Equation 3 can be obtained by finding a point where 0 is obtained by partially differentiating the energy function of Equation 3 by a, b and c. Equations obtained by partially differentiating the energy function of Equation 3 by a, b and c are Equations 4 below:

$$\frac{\partial e}{\partial a} = {\sum }_{i = 0}^{n - 1} ( a ( {x}_{i}^{2} + {y}_{i}^{2} ) + {bx}_{i} + {cy}_{i} + 1 ) ( {x}_{i}^{2} + {y}_{i}^{2} ) = 0 \\ \frac{\partial e}{\partial b} = {\sum }_{i = 0}^{n - 1} ( a ( {x}_{i}^{2} + {y}_{i}^{2} ) + {bx}_{i} + {cy}_{i} + 1 ) {x}_{i} = 0 \\ \frac{\partial e}{\partial c} = {\sum }_{i = 0}^{n - 1} ( a ( {x}_{i}^{2} + {y}_{i}^{2} ) + {bx}_{i} + {cy}_{i} + 1 ) {y}_{i} = 0 \qquad 〈 Equations 4 〉$$

Equations 4 may be arranged as a linear algebraic equation, as shown in Equation 5 below:

$$[ \begin{matrix}\begin{matrix}{\sum }_{i = 0}^{n - 1} ( {a ( {x}_{i}^{2} + {y}_{i}^{2} )}^{2} + {bx}_{i} ( {x}_{i}^{2} + {y}_{i}^{2} ) + {cy}_{i} ( {x}_{i}^{2} + {y}_{i}^{2} ) + \\ ( {x}_{i}^{2} + {y}_{i}^{2} ) )\end{matrix} \\ {\sum }_{i = 0}^{n - 1} ( a ( {x}_{i}^{2} + {y}_{i}^{2} ) {x}_{i} + {bx}_{i}^{2} + {cx}_{i} {y}_{i} + {x}_{i} ) \\ {\sum }_{i = 0}^{n - 1} ( a ( {x}_{i}^{2} + {y}_{i}^{2} ) {y}_{i} + {bx}_{i} {y}_{i} + {cy}_{i}^{2} + {y}_{i} )\end{matrix} ] = [ \begin{matrix}0 \\ 0 \\ 0\end{matrix} ] ⇒ [ \begin{matrix}{\sum }_{i = 0}^{n - 1} {( {x}_{i}^{2} + {y}_{i}^{2} )}^{2} {\sum }_{i = 0}^{n - 1} {x}_{i} ( {x}_{i}^{2} + {y}_{i}^{2} ) {\sum }_{i = 0}^{n - 1} {y}_{i} ( {x}_{i}^{2} + {y}_{i}^{2} ) \\ \begin{matrix}{\sum }_{i = 0}^{n - 1} {x}_{i} ( {x}_{i}^{2} + {y}_{i}^{2} ) & {\sum }_{i = 0}^{n - 1} {x}_{i}^{2} & {\sum }_{i = 0}^{n - 1} {x}_{i} {y}_{i}\end{matrix} \\ \begin{matrix}{\sum }_{i = 0}^{n - 1} {y}_{i} ( {x}_{i}^{2} + {y}_{i}^{2} ) & {\sum }_{i = 0}^{n - 1} {x}_{i} {y}_{i} & {\sum }_{i = 0}^{n - 1} {y}_{i}^{2}\end{matrix}\end{matrix} ] [ \begin{matrix}a \\ b \\ c\end{matrix} ] = [ \begin{matrix}- {\sum }_{i = 0}^{n - 1} ( {x}_{i}^{2} + {y}_{i}^{2} ) \\ - {\sum }_{i = 0}^{n - 1} {x}_{i} \\ - {\sum }_{i = 0}^{n - 1} {y}_{i}\end{matrix} ] \qquad 〈 Equation 5 〉$$

When a solution to the linear algebraic equation of Equation 5 is obtained, the values of a, b and c are obtained, and thus the location of the center and radius of the circle drawn by the user via the hand, finger or joint can be obtained.

Thereafter, the direction and extent of the rotation of the plurality of icons intended by the user may be calculated by substituting the location of the center of the circle and the location sequence information H into Equation 6.

$$s = {\sum }_{i = 0}^{n - 2} \vert \begin{matrix}{x}_{i} - {r}_{x} {x}_{i + 1} - {r}_{x} \\ {y}_{i} - {r}_{y} {y}_{i + 1} - {r}_{y}\end{matrix} \vert \cdot \vert \begin{matrix}a & b \\ c & d\end{matrix} \vert = ab - bc \qquad 〈 Equation 6 〉$$

In the above equation, (rx,ry) is the location of the center of the circle, and (x,y) are coordinates constituting the location sequence information H. Furthermore, Equation 6 is an equation for calculating the sum of triangular areas having a sign. When a right-handed coordinate system is used as a reference system, s refers to a negative value when the hand, finger or joint of the user is rotated in the clockwise direction of a z axis, and s refers to a positive value when the hand, finger or joint of the user is rotated in the counterclockwise direction of the z axis. Furthermore, the absolute value of s refers to the extent of the rotation. That is, the simple definition (direction of rotation, extent of rotation)=(the sign of s, |s|) can be given.

In summary, when a user performs an action, such as an action of rotating a hand or a finger in a clockwise direction or a counterclockwise direction, the rotation action information generation unit 231 determines the direction and extent of the rotation intended by the user, and generates rotation action information.

Thereafter, the selection action information generation unit 232 determines a location where acceleration increases rapidly from information about the successive locations of the hand, finger or joint of the user included in the recognition information, and generates selection action information when the magnitude of the acceleration is equal to or higher than a reference value, and determines that there is no input action for the interactive interface when the magnitude of the acceleration is lower than the reference value.

A method by which the selection action information generation unit 232 finds the location where acceleration increases rapidly is as follows. First, a Gaussian kernel convolution, such as Equation 7, is applied to the location sequence information H converted into coordinates via Equation 1. Sequence information H′ calculated as a result of the application of the Gaussian kernel convolution is smooth location sequence information from which noise has been eliminated.

$${H}^{′} = \{ {p}_{0}^{′} \cdot {p}_{1}^{′} \cdot {p}_{2}^{′} … {p}_{n - 1}^{′} \} \cdot {p}_{i}^{′} = {\sum }_{j = i - k}^{i + k} {g}_{σ} ( j - i ) {p}_{j} \qquad 〈 Equation 7 〉$$

In the above equation, g(j−i) is a Gaussian kernel function, k is the magnitude of a Gaussian kernel, σ is the standard deviation of the Gaussian kernel, and k and σ are predefined inside the interface provision device 200.

Thereafter, an equation regarding acceleration ai, such as Equation 8 below, is obtained by differentiating the location sequence information H′, from which noise has been eliminated, twice, and acceleration sequence information A regarding the magnitude of the acceleration is obtained. In this case, the differentiation is performed as finite differentiation due to the characteristic of the acceleration sequence information A.

A={a₀·a₁·a₂ . . . aₙ₋₃}. aᵢ=∥vᵢ₊₁∥−∥vᵢ∥. vᵢ=pᵢ₊₁−pᵢ <Equation 8>

Thereafter, a peak point where the magnitude of the acceleration is highest is found from the acceleration sequence information A, and the direction of the action of the user (i.e., the direction in which the hand or finger is moved to select an icon) is calculated from Equation 9 below when the peak point is equal to or higher than a reference value:

$$t = {tan}^{- 1} ( \frac{{y}_{e + 1} - {y}_{e}}{{x}_{e + 1} - {x}_{e}} ) \qquad 〈 Equation 9 〉$$

(x,y) are the coordinates of the location sequence information H, and t is a direction angle.

However, when the value of the peak point where the magnitude of the acceleration is highest is lower than a reference value, it is determined that there is no input action for the interactive interface.

In summary, when the user moves a finger, a hand or the like in a specific direction within a short period of time, the selection action information generation unit 232 determines information about the specific direction, and generates selection action information.

An execution information provision unit 240 generates execution information adapted to execute the interactive interface based on the action information, and provides the execution information to the image display device 300.

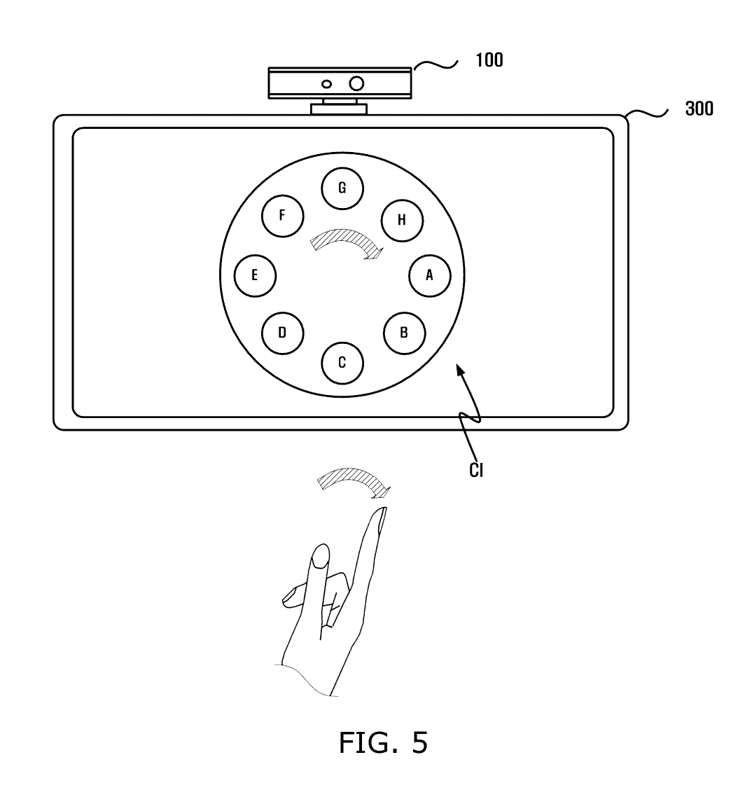

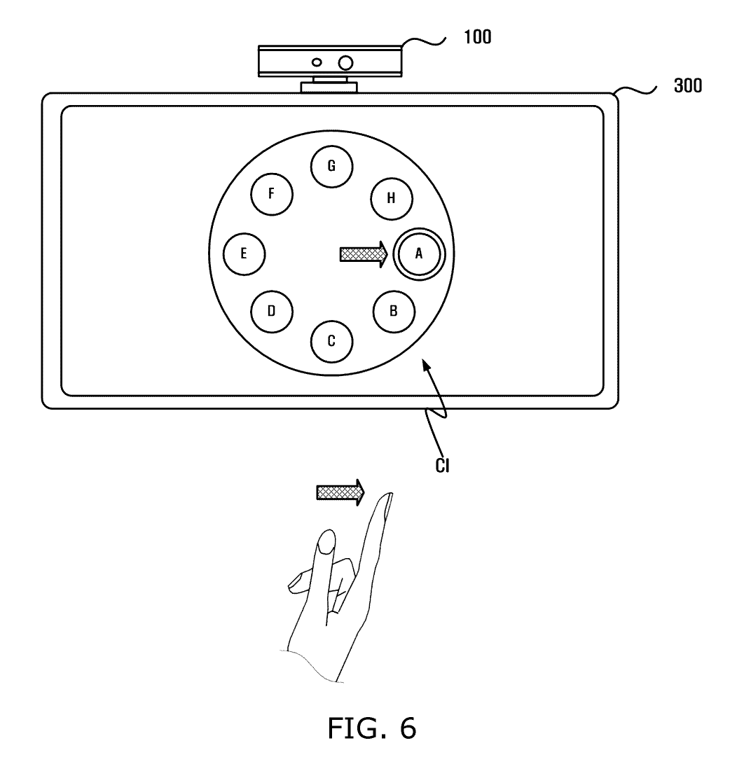

For example, the rotation action information may include a command to rotate a plurality of icons in a clockwise direction by the length of an arrow, as shown in FIG. 5. In connection with this, the execution information provision unit 240 generates execution information adapted to rotate a circular interactive interface CI, as shown in FIG. 5, and provides the execution information to the image display device 300. Furthermore, the selection action information may include a command to request the execution of an icon disposed in a right direction, as shown in FIG. 6. In connection with this, the execution information provision unit 240 generates execution information adapted to execute icon A disposed in the right direction, and provides the execution information to the image display device 300.

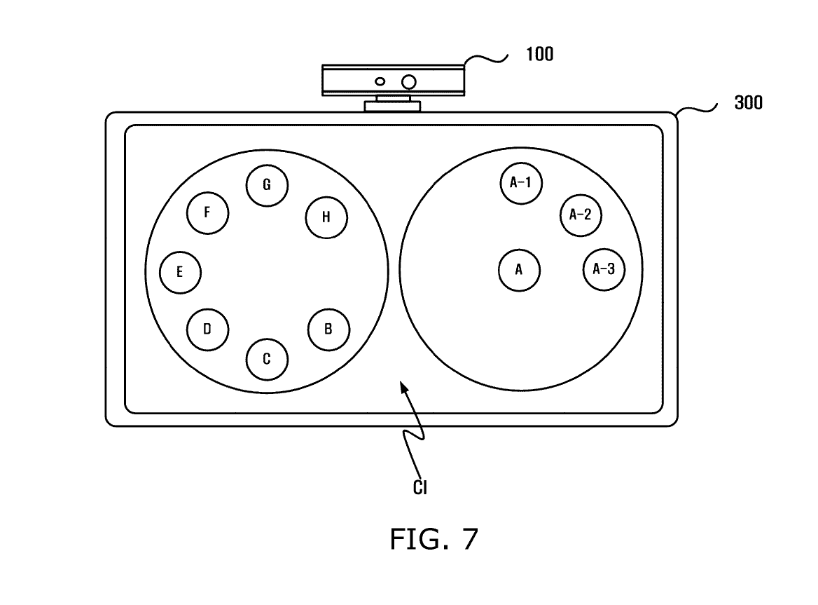

Furthermore, when icon A is an icon linked to an executable file for application A, the execution information provision unit 240 provides execution information for application A to the image display device 300. However, when icon A is a high-level group icon including the icons of a low-level group, the execution information provision unit 240 provides execution information adapted to display the icons of the low-level group to the image display device 300, as shown in FIG. 7. In FIG. 7, icons A-1, A-2 and A-3 are separately displayed as a low-level group for icon A.

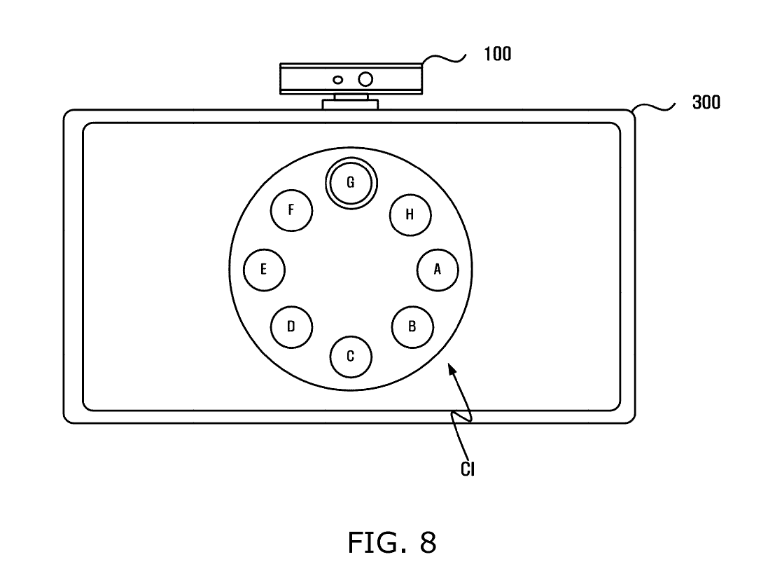

Meanwhile, as an additional embodiment, the selection of an icon may be performed by using a method of automatically selecting icon G disposed at a preset location (for example, the top of a circle), as shown in FIG. 8, rather than by performing a selection action, as shown in FIG. 6. Alternatively, processing may be made such that when action information indicating moving a hand in a specific direction is received from the user after only preliminary information indicating that icon G disposed at a preset location becomes a selection target has been provided (by indicating icon G with double lines), the selection of icon G is completed.

Furthermore, in another additional embodiment, the selection of an icon may be performed via an action of clenching a first or an action of opening a fist. For example, the selection action information generation unit 232 may recognize a selection action from a situation in which five fingers are accelerated and generate selection action information, or may store information about the clenching of a first and the opening of a first in advance and recognize a selection action when matching information is received.

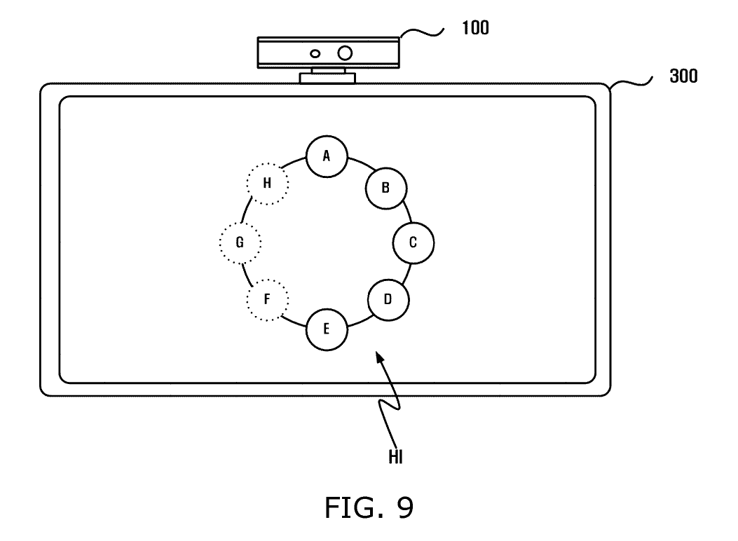

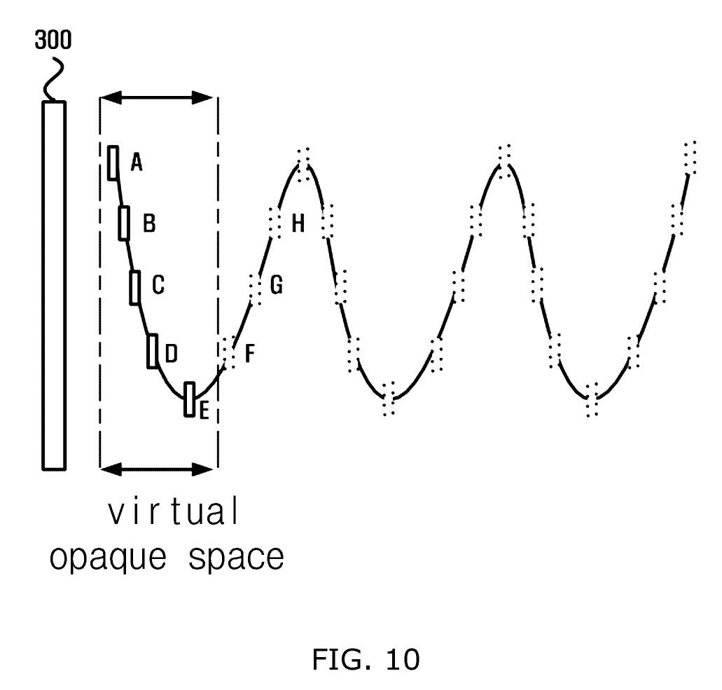

Furthermore, as still another embodiment, when it is difficult to include all icons in a circular interactive interface CI, the interface provision unit 210 may provide a spiral interactive interface HI. Referring to FIG. 9, a plurality of icons appears to be circularly arranged in the spiral interactive interface HI when viewed from the front. However, referring to the side of the spiral interactive interface HI shown in FIG. 10, the icons are shown as being arranged along a zigzag spiral section. FIG. 10 shows a side surface of a virtual space displayed on the image display device 300, which means that the spiral interactive interface HI is provided for the user in a 3D spiral form. Furthermore, although a large number of icons are actually displayed, only top icons appear to be circularly arranged in FIG. 9 due to the superposition of icons.

Furthermore, referring to FIG. 10, in the spiral interactive interface HI, a virtual opaque space is defined. The virtual opaque space is a region within a predetermined distance from the screen of the image display device 300. Referring to FIGS. 9 and 10 together, the contours of icons (icons arranged within a predetermined distance from the top of the spiral arrangement: icon A to icon E) disposed in the virtual opaque space are shown as being clear, and icons (icon F to icon H, and icons arranged below icon H) not arranged in the virtual opaque space are shown as being translucent. The reason for being displayed as being translucent is to indicate distances from the screen of the image display device 300 and increase the level of concentration on the icons arranged adjacent to the user.

In this case, the transparencies of the icons may be adjusted based on the locations thereof. For example, to indicate the depth of the 3D spiral arrangement, the transparencies of respective icons may be set to different values. Alternatively, even within a single icon, transparencies may be set to different values.

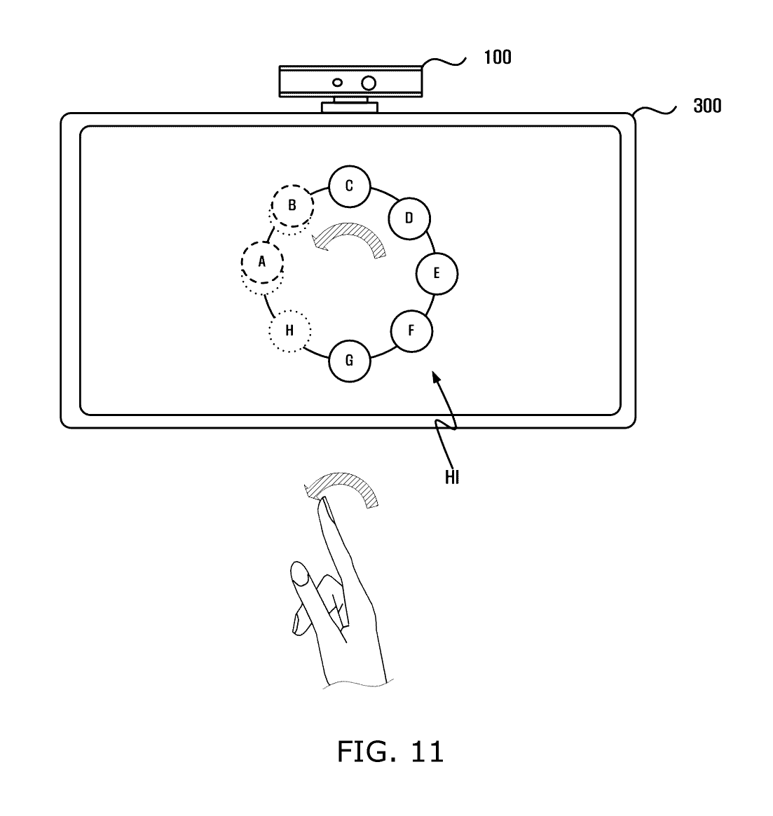

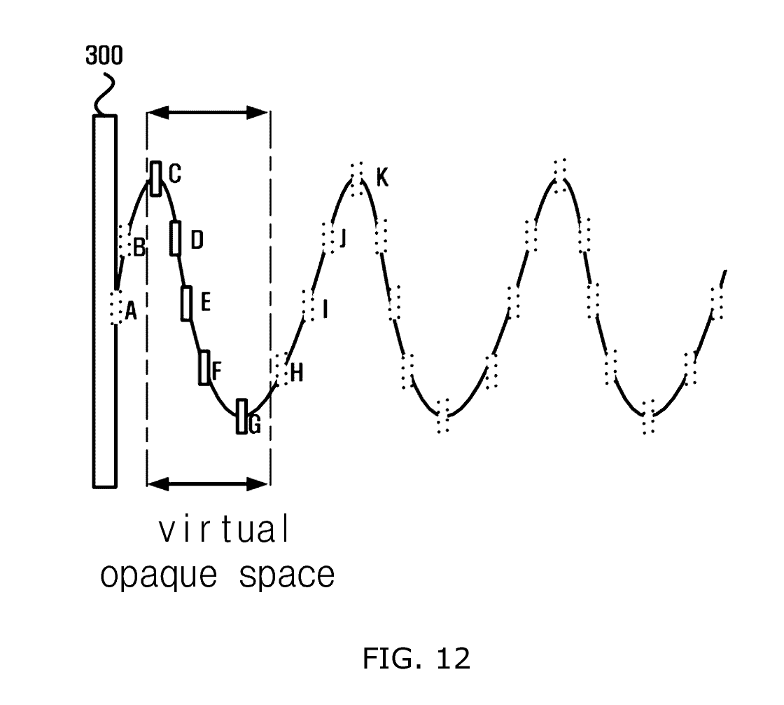

Thereafter, when the user rotates the spiral interactive interface HI in a counterclockwise direction via a hand action, this situation is shown as illustrated in FIG. 11. That is, referring to FIG. 12, the spiral interactive interface HI is raised in the direction of the screen of the image display device 300 in response to the action of a user. Accordingly, the icons A and B depart from the virtual opaque space, and are displayed as being translucent (or may be displayed as being completely transparent). Furthermore, the icons F and G enter into the virtual opaque space, and are displayed as being clear. That is, the spiral interactive interface HI is raised or lowered in the direction of the screen of the image display device 300 depending on a user action of rotating a hand, thereby displaying the icons in order to provide distances to the icons.

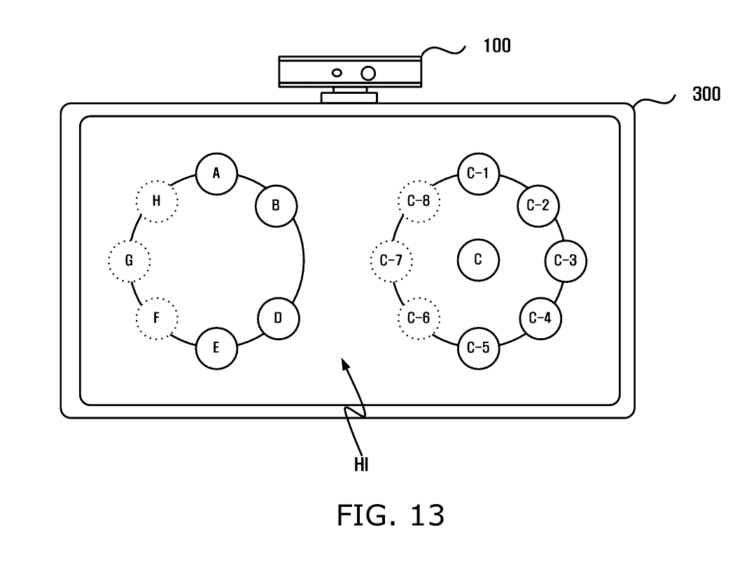

Furthermore, as shown in FIG. 13, when the user selects icon C including the icons of a low-level group, the execution information provision unit 240 may generate execution information so that the icons of the low-level group can be also displayed in a 3D spiral form.

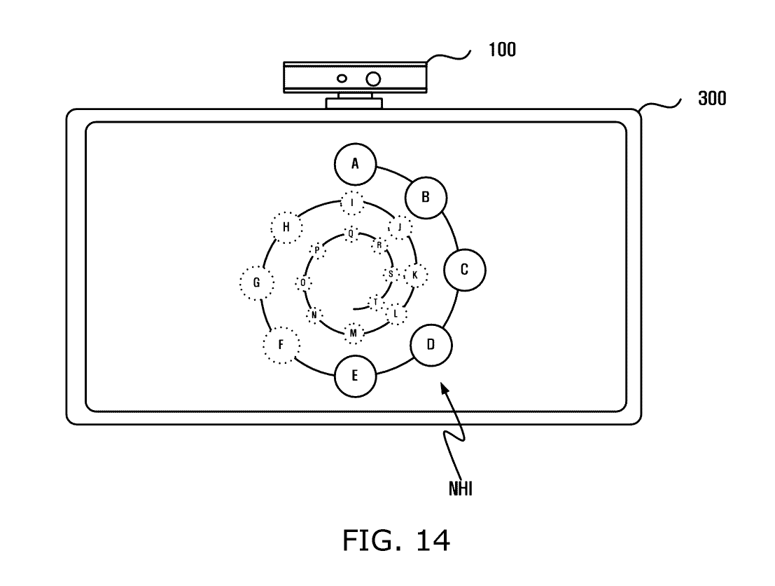

Meanwhile, the interface provision unit 210 may provide a spiral interactive interface NHI, such as that of FIG. 14. The interface NHI of FIG. 14 is different from the interfaces of FIGS. 9 to 13 in that the interface NHI has a form in which the diameter of a 3D spiral arrangement decreases in proportion to a distance from the screen of the image display device 300.

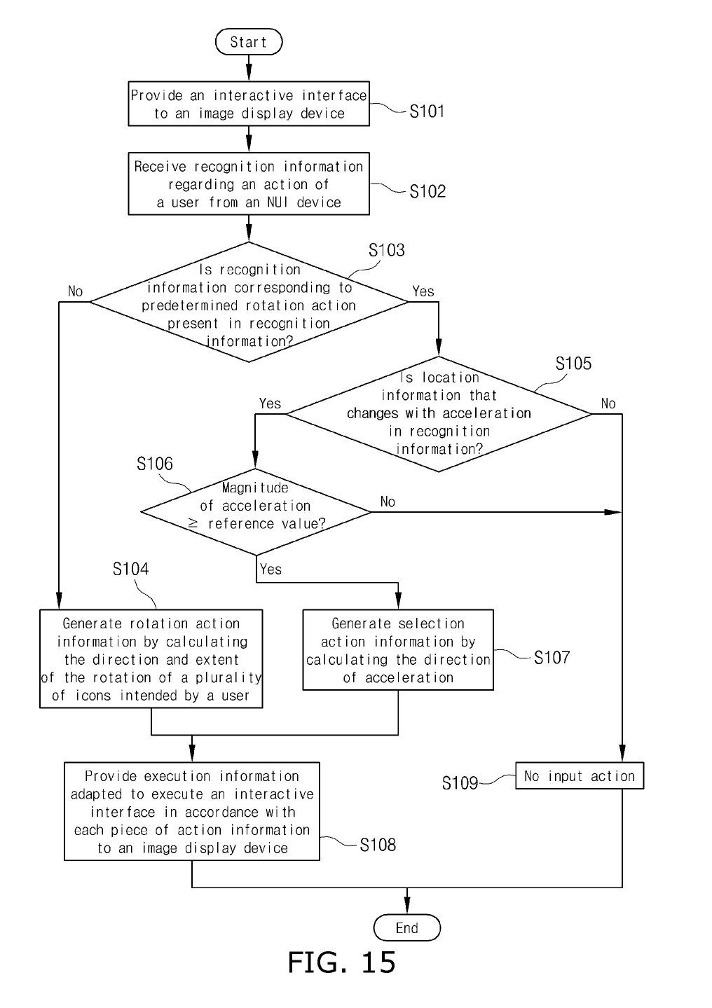

Referring to FIG. 15, a method for providing an interface interacting with a user via the NUI device 100 according to an embodiment of the present invention will be described below in greater detail. The method shown in FIG. 15 includes steps that are processed in the interface provision device 200 in a time sequential manner. Accordingly, the items that are omitted below but have been described in conjunction with the interface provision device 200 may be also applied to the method according to the embodiment of FIG. 15.

First, the interface provision device 200 provides an interactive interface to the image display device 300 at step S101. The interactive interface is configured in a circular form, such as those of FIGS. 4 to 8, or in a 3D spiral form, such as those of FIGS. 9 to 13 or that of FIG. 14, and is an interface in which a plurality of icons are arranged and which enables the user to select any one of the plurality of icons.

Thereafter, the interface provision device 200 receives recognition information regarding an action of a user from the NUI device 100 at step S102. For example, the interface provision device 200 may receive recognition information, including information about the successive locations of a hand, finger or joint of the user, from a depth camera.

The interface provision device 200 determines whether recognition information corresponding to preset rotation action recognition information is present in the former recognition information at step S103. For example, information that can be maintained for a predetermined period of time, such as an action of clenching a fist, an action of bringing fingers into contact with each other, or the like, may be set as the rotation action recognition information in advance.

When recognition information corresponding to the preset rotation action recognition information is present, the interface provision device 200 determines that the recognition information includes information about a continuous rotation action, and generates rotation action information by calculating the direction and extent of the rotation of the plurality of icons intended by the user at step S104. For example, when the user draws a circle or an arc via a hand action, the interface provision device 200 generates rotation action information including the direction and extent in which and to which the circle or arc is drawn.

In contrast, when recognition information corresponding to the preset rotation action recognition information is not present, the interface provision device 200 determines whether location information that changes with acceleration is present in the recognition information at step S105.

When the location information that changes with acceleration is present, the interface provision device 200 determines whether the magnitude of the acceleration is equal to or higher than a reference value at step S106.

When the magnitude of the acceleration is higher than the reference value, the interface provision device 200 generates selection action information by calculating the direction of the acceleration at step S107. For example, when the user rapidly moves a finger to the right, the interface provision device 200 generates selection action information adapted to request the selection of an icon disposed on the right side.

Finally, the interface provision device 200 provides execution information adapted to execute the interactive interface based on the action information to the image display device 300 at step S108. For example, the interface provision device 200 provides execution information adapted to move the plurality of icons in a clockwise direction by a predetermined length based on the rotation action information or execution information adapted to activate an icon disposed on the icon disposed on the right side based on the selection action information to the image display device 300.

Meanwhile, when location information that changes with acceleration is present in the recognition information at step S105 or the magnitude of the acceleration is lower than the reference value, the action of the user is an action of the user that cannot be recognized by the interactive interface or a current state is the state in which an action of the user is not present, and thus the interface provision device 200 determines that there is no input action at step S109.

The above-described embodiment of the present invention provides the interactive interface adapted to enable an icon to be selected via a simple input, such as an input adapted to rotate a hand action or an input adapted to move a hand action in one direction, thereby providing a convenient and optimized interface environment for a user. Furthermore, the interactive interface is configured in a 3D spiral form, and thus a large number of icons can be included and an intuitive interface environment can be provided for a user.

The method described via FIG. 15 may be implemented may also be implemented in the form of a storage medium including computer-executable instructions, such as a program module executed by a computer. A computer-readable medium may be any available medium accessible to a computer, and includes all volatile and non-volatile media and separable and non-separable media. Furthermore, the computer-readable medium may include both a computer storage medium and a communication medium. The computer storage medium includes all volatile and non-volatile media and separable and non-separable media implemented using any method or technique for storing information, such as computer-readable instructions, data structures, program modules, and other data. The communication medium typically includes computer-readable instructions, data structures, program modules, other data of a modulated data signal, such as carriers, or other transmission mechanisms, and also includes any information transfer media.

Furthermore, the method according to an embodiment of the present invention may be implemented using a computer program (or a computer program product) including a computer-executable instructions. The computer program includes programmable machine instructions processed by a processor, and may be implemented using a high-level programming language, an object-oriented programming language, an assembly language, or a machine language. Furthermore, the computer program may be recorded on a variety of types of computer-readable storage media (e.g., memory, a hard disk, a magnetic/optical medium, or a solid-state drive (SSD)).

Accordingly, the method according to an embodiment of the present invention may be implemented when a computer program, such as that described above, is executed by a computing device. The computing device may include at least some of a processor, memory, a storage device, a high-speed interface connected to the memory and a high-speed extension port, and a low-speed interface connected to a low-speed bus and the storage device. These components are interconnected using various buses, and may be mounted on a common motherboard or may be mounted using other appropriate methods.

In this case, the processor may process instructions within the computing device. The instructions may be, for example, instructions stored in memory or a storage device in order to display graphic information adapted to provide a graphic user interface (GUI) on an external input/output device, such as a display connected to a high-speed interface. As another embodiment, a plurality of processors and/or a plurality of buses may be appropriately used along with a plurality of pieces of memory and a plurality of memory forms. Furthermore, the processor may be implemented using a chipset formed by chips that include a plurality of analog and/or digital processors.

Furthermore, the memory stores information within the computing device. As an example, the memory may include a volatile memory unit or a set of volatile memory units. As another example, the memory may include a non-volatile memory unit or a set of non-volatile memory units. Furthermore, the memory may be another type of computer-readable medium, such as a magnetic or optical disk.

Furthermore, the storage device may provide a large storage space to the computing device. The storage device may be a computer-readable medium, or may be a component including the computer-readable medium. For example, the storage device may also include devices within a storage area network (SAN) or other components, and may be a floppy disk device, a hard disk device, an optical disk device, a tape device, flash memory, or a similar semiconductor memory device or device array.

The above detailed description of the present invention is merely for an illustrative purpose. It will be understood that those having ordinary knowledge in the art to which the present invention pertains can easily make modifications and variations without departing from the technical spirit and essential features of the present invention. Therefore, the above-described embodiments are illustrative in all aspects, and are not limitative. For example, each component described as being in a single form may be practiced in a distributed form. In the same manner, components described as being in a distributed form may be practiced in an integrated form.

The scope of the present invention is defined by the attached claims, rather than the detailed description. Furthermore, all modifications and variations derived from the meanings, scope and equivalents of the claims should be construed as falling within the scope of the present invention.

What is claimed is:

1. A method for providing an interface interacting with a user via an NUI device, which is performed by an apparatus for providing an interface, the method comprising:
(a) providing an interactive interface, in which a plurality of icons are circularly arranged, to an image display device;
(b) recognizing, by a Natural User Interface (NUI) device, an action of a user, and receiving recognition information regarding the action of the user from the NUI device;
(c) analyzing the recognition information, and generating action information regarding any one of a user action of rotating the plurality of icons circularly arranged and a user action of selecting any one of the plurality of icons; and
(d) providing an interactive interface, in which a command has been executed in accordance with the action information, to the image display device;
wherein step (d) comprises, when the action information corresponds to the user action of selecting the any one icon, extracting a direction included in the action information, executing an icon disposed at a location corresponding to the direction, and providing execution information adapted to execute an application to the image display device when the executed icon is an icon including an executable command for the application, or providing execution information adapted to display icons of a low-level group to the image display device when the executed icon is a high-level group icon including the icons of the low-level group.

2. The method of claim 1, wherein step (a) comprises providing a spiral interactive interface in which the plurality of icons appear to be circularly arranged when the plurality of icons arranged in a 3D spiral arrangement are viewed from one direction.

3. The method of claim 2, wherein step (a) comprises:
defining a virtual opaque space in a virtual space in which the 3D spiral arrangement where the plurality of icons are arranged is displayed; and
providing the interactive interface so that transparencies of the icons are adjusted and displayed based on whether the icons arranged in the 3D spiral arrangement are included in the virtual opaque space.

4. The method of claim 3, wherein step (d) comprises providing execution information to the image display device, wherein the execution information is adapted to, when the 3D spiral arrangement is rotated in accordance with the action information, display an icon, which has been included in and departs from the virtual opaque space in response to the rotation of the 3D spiral arrangement, so that a transparency thereof is increased, and display an icon, which has been outside and enters into the virtual opaque space in response to the rotation of the 3D spiral arrangement, so that a transparency thereof is decreased.

5. The method of claim 1, wherein step (b) comprises receiving recognition information, including at least one of information about a location of a hand or a joint of the user, information about rotation of the hand or joint of the user, and information about opening of the hand or clenching of a first of the user, from the NUI device.

6. The method of claim 1, wherein step (c) comprises:
(c-1) when recognition information corresponding to preset rotation action recognition information is present in the former recognition information, generating action information regarding the user action of rotating the plurality of icons; and
(c-2) when recognition information corresponding to preset rotation action recognition information is not present in the former recognition information, generating action information regarding the user action of selecting the any one of the plurality of icons.

7. The method of claim 6, wherein step (c-1) comprises:
calculating a direction and extent of the rotation of the plurality of icons, intended by the user, via the recognition information, and generating action information including a command regarding the direction and extent of the rotation.

8. The method of claim 7, wherein step (c-1) comprises:
representing information about successive locations of a hand or joint of the user, included in the recognition information, with coordinates;
calculating a location of a center or radius of a circle or an arc drawn by the hand or joint of the user by substituting the location information represented with the coordinates into circular approximation via a least-square method; and
generating the action information by calculating the direction and extent of the rotation of the plurality of icons by using the location of the center and radius of the circle or arc and the coordinates of the location information.

9. The method of claim 6, wherein step (c-2) comprises:
(c-3) when information in which a location of any point of the hand and joint of the user changes with a predetermined acceleration is present in the recognition information, generating action information regarding a user action of selecting an icon when a magnitude of the acceleration is equal to or higher than a reference value, and determining that there is no input action of the user when the magnitude of the acceleration is lower than the reference value; and
(c-4) when information in which a location of any point of the hand and joint of the user changes with a predetermined acceleration is not present in the recognition information, determining that there is no input action of the user.

10. The method of claim 9, wherein step (c-3) comprises:
representing information about successive locations of the hand or joint of the user included in the recognition information with coordinates;
eliminating noise by applying a Gaussian kernel convolution to the location information represented with the coordinates;
obtaining an equation for the magnitude of the acceleration by differentiating the location information from which the noise has been eliminated;
obtaining a peak point where the magnitude of the acceleration is highest from the equation for the magnitude of the acceleration, and determining whether the peak point is higher than the reference value; and
generating action information regarding a user action of selecting an icon by calculating a direction of the action of the user when the magnitude of the acceleration is equal to or higher than the reference value, and determining that there is no input action of the user when the magnitude of the acceleration is lower than the reference value.

11. The method of claim 1, wherein the NUI device is a device for recognizing an action or voice of the user via at least one of an image sensor, a depth sensor, and a voice recognition sensor.

12. An apparatus for providing an interface interacting with a user via an NUI device, the apparatus comprising:
an interface provision unit configured to provide an interactive interface, in which a plurality of icons are circularly arranged, to an image display device;
a recognition information reception unit configured to receive recognition information regarding an action of a user, recognized by a Natural User Interface (NUI) device, from the NUI device;
an action information generation unit configured to analyze the recognition information and generate action information regarding any one of a user action of rotating the plurality of icons circularly arranged and a user action of selecting any one of the plurality of icons; and
an execution information provision unit configured to provide execution information adapted to execute an interactive interface in accordance with the action information to the image display device;
wherein the execution information provision unit, when the action information corresponds to the user action of selecting the any one icon, extracts a direction included in the action information, executes an icon disposed at a location corresponding to the direction, and provides execution information adapted to execute an application to the image display device when the executed icon is an icon including an executable command for the application, or provides execution information adapted to display icons of a low-level group to the image display device when the executed icon is a high-level group icon including the icons of the low-level group.

13. The apparatus of claim 12, wherein the interface provision unit provides a spiral interactive interface in which the plurality of icons appear to be circularly arranged when the plurality of icons arranged in a 3D spiral arrangement are viewed from one direction.

14. The apparatus of claim 13, wherein the interface provision unit:
defines a virtual opaque space in a virtual space in which the 3D spiral arrangement where the plurality of icons are arranged is displayed; and
provides the interactive interface so that transparencies of the icons are adjusted and displayed based on whether the icons arranged in the 3D spiral arrangement are included in the virtual opaque space.

15. The apparatus of claim 14, wherein the execution information provision unit provides execution information to the image display device, wherein the execution information is adapted to, when the 3D spiral arrangement is rotated in accordance with the action information, display an icon, which has been included in and departs from the virtual opaque space in response to the rotation of the 3D spiral arrangement, so that a transparency thereof is increased, and display an icon, which has been outside and enters into the virtual opaque space in response to the rotation of the 3D spiral arrangement, so that a transparency thereof is decreased.

16. The apparatus of claim 12, wherein the recognition information reception unit receives recognition information, including at least one of information about a location of a hand or a joint of the user, information about rotation of the hand or joint of the user, and information about opening of the hand or clenching of a first of the user, from the NUI device.

17. The apparatus of claim 12, wherein the action information generation unit comprises:
a rotation action information generation unit configured to, when recognition information corresponding to preset rotation action recognition information is present in the former recognition information, generate action information regarding the user action of rotating the plurality of icons; and
a selection action information generation unit configured to, when recognition information corresponding to preset rotation action recognition information is not present in the former recognition information, generate action information regarding the user action of selecting the any one of the plurality of icons.

18. The apparatus of claim 17, wherein the rotation action information generation unit:
calculates a direction and extent of the rotation of the plurality of icons, intended by the user, via the recognition information, and generates action information including a command regarding the direction and extent of the rotation.

19. The apparatus of claim 18, wherein the rotation action information generation unit:
represents information about successive locations of a hand or joint of the user, included in the recognition information, with coordinates;
calculates a location of a center or radius of a circle or an arc drawn by the hand or joint of the user by substituting the location information, represented with the coordinates, into circular approximation via a least-square method; and
generates the action information by calculating the direction and extent of the rotation of the plurality of icons by using the location of the center and radius of the circle or arc and the coordinates of the location information.

20. The apparatus of claim 17, wherein the selection action information generation unit:
when information in which a location of any point of the hand and joint of the user changes with a predetermined acceleration is present in the recognition information, generates action information regarding a user action of selecting an icon when a magnitude of the acceleration is equal to or higher than a reference value, and determines that there is no input action of the user when the magnitude of the acceleration is lower than the reference value.

21. The apparatus of claim 20, wherein the selection action information generation unit:
represents information about successive locations of the hand or joint of the user, included in the recognition information, with coordinates;
eliminates noise by applying a Gaussian kernel convolution to the location information represented with the coordinates;
obtains an equation for the magnitude of the acceleration by differentiating the location information from which the noise has been eliminated;
obtains a peak point where the magnitude of the acceleration is highest from the equation for the magnitude of the acceleration, and determines whether the peak point is higher than the reference value; and
generates action information regarding a user action of selecting an icon by calculating a direction of the action of the user when the magnitude of the acceleration is equal to or higher than the reference value, and determines that there is no input action of the user when the magnitude of the acceleration is lower than the reference value.

22. A computer program stored in a computer-readable storage medium to perform the method for providing an interface interacting with a user via an NUI device according to claim 1.

23. A computer-readable storage medium having stored thereon a computer program code for performing the method for providing an interface interacting with a user via an NUI device according to claim 1.
